(19) United States
(12) Patent Application Publication
(10) Pub. No.: US 2018/0211796 A1
(43) Pub. Date: Jul. 26, 2018

(54) DRIVE UNIT FOR A MEDIUM VOLTAGE OR HIGH VOLTAGE CIRCUIT BREAKER

(71) Applicant: General Electric Technology GmbH, Baden (CH)

(72) Inventors: Daniel KALIN, Oberentfelden (CH); Peter VON ALLMEN, Kirchleerau (CH)

(21) Appl. No.: 15/741,733

(22) PCT Filed: Jul. 1, 2016
(86) PCT No.: PCT/EP2016/065478

§ 371 Date: Jan. 3, 2018

(30) Foreign Application Priority Data
Jul. 3, 2015 (EP) 15175341.5

(51) Int. Cl. H01H 3/30

(52) U.S. Cl. CPC H01H 3/3005; H01H 3/38; H01H 3/3031

(57) ABSTRACT

The invention concerns a drive unit for a high and medium voltage circuit breaker comprising of a main shaft being rotatable around its main axis between a first position corresponding to a closed state of the circuit breaker and a second position corresponding to an opened state of the circuit breaker, elastic means for driving the main shaft in rotation towards the second position, and releasable means for preventing the rotation of the main shaft from the second position towards the first position, wherein the releasable means comprise retention pawl which removably engages the main shaft and which, when engaged, enables the main shaft to rotate towards the second position but prevents its rotation from the second position towards the first position.

### TECHNICAL FIELD OF THE INVENTION

The invention concerns a drive unit for a high and medium voltage circuit breaker comprising means for preventing a main shaft from rotating from a position corresponding to an opened state of the circuit breaker.

### BACKGROUND OF THE INVENTION

A drive unit for a circuit breaker comprises, amongst other components, a main shaft for driving mobile parts of the circuit breaker.

This main shaft is rotatable between a two position, respectively corresponding to an opened state and a closed state of the circuit breaker.

In a spring-operated drive unit, the main shaft is maintained in the closed position by a latching system. A preloaded spring exerts a driving force on the main shaft for driving the main shaft towards the opened position.

When the latching system is released, the main shaft automatically rotates towards the opened position.

Generally, the driving force exerted by the spring remains, even when the main shaft is in the second position, in order to prevent the return of the main shaft towards the closed position.

However, due to the fact that the force exerted by the spring is lower when the main shaft is in opened position than when the main shaft is in closed position, it's possible that the mechanism can't be correctly maintained in the opened position only by the spring.

A solution is to increase the value of the force exerted by the spring. This solution also implies the augmentation of the size of several components of the drive unit and thus, the weight and costs of the drive unit.

Another solution is to use a linkage between the drive unit and the circuit breaker that goes through a dead center when the drive unit operates the circuit breaker.

This solution prevents an unwanted rotation of the main shaft back to the closed position of the circuit breaker, but it reduces the efficiency of the force transmission. This implies a need to upsize the drive unit.

The invention aims to provide a drive unit which does not need an upsizing of its components while still preventing an unwanted rotation of the main shaft back towards the closed position of the circuit breaker.

### SUMMARY OF THE INVENTION

The invention concerns a drive unit for a high and medium voltage circuit breaker comprising a main shaft being rotatable around its main axis (A) between a first position corresponding to a closed state of the circuit breaker and a second position corresponding to an opened state of the circuit breaker, elastic means for driving the main shaft in rotation towards the second position, and releasable means for preventing the rotation of the main shaft from the second position towards the first position, wherein the releasable means comprise a retention pawl which removably engages the main shaft and which, when engaged, enables the main shaft to rotate towards the second position but prevents its rotation from the second position towards the first position.

When engaging with the main shaft, the retention pawl restrains the rotation of the main shaft towards its first position, while permitting its rotation towards the second position.

Then, there can't be any unwanted rotation of the main shaft towards its first position.

The components of the drive unit don't need to be upsized, the drive unit then remains compact and lightweight.

In an embodiment, the drive unit further comprises a rotating cam which selectively engages the retention pawl to drive the pawl in a position disengaged from the main shaft.

In an embodiment, the drive unit further comprises a secondary shaft engaging with the main shaft, for driving the main shaft in rotation from the second position towards the first position.

In an embodiment, the secondary shaft engages with the main shaft when the rotating cam engages the retention pawl.

In an embodiment, the rotating cam is mounted on the secondary shaft.

In an embodiment, the main shaft comprises multiple teeth for engaging with the retention pawl.

In an embodiment, the pawl comprises a leg on which the cam presses to rotate the pawl from a position engaged with the main shaft to a position disengaged from the main shaft.

In an embodiment, the drive unit further comprises a return spring continuously urging the pawl towards its engaged position.

### DESCRIPTION OF THE DRAWINGS

The present invention will now be described in more detail with reference to the enclosed drawings, illustrating an embodiment of the invention as an example only, in which:

FIG. 1 is a schematic representation of the drive unit wherein the main shaft is in its first position; and

FIGS. 2 to 5 are views similar to the one in FIG. 1, representing various states of the drive unit.

### DETAILED DESCRIPTION OF THE INVENTION

A drive unit 10 for a medium voltage or high voltage circuit breaker (not shown) is represented on the drawings.

The drive unit 10 comprises a main shaft 12 for driving movable components of the circuit breaker between a closed state of the circuit breaker and an opened state.

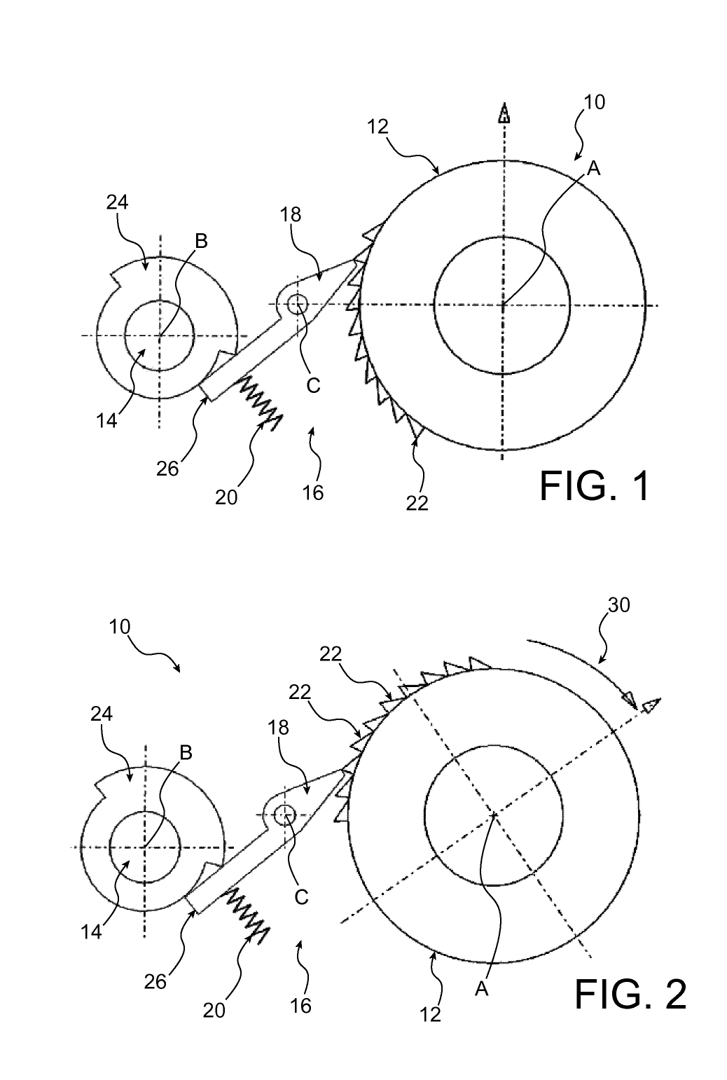

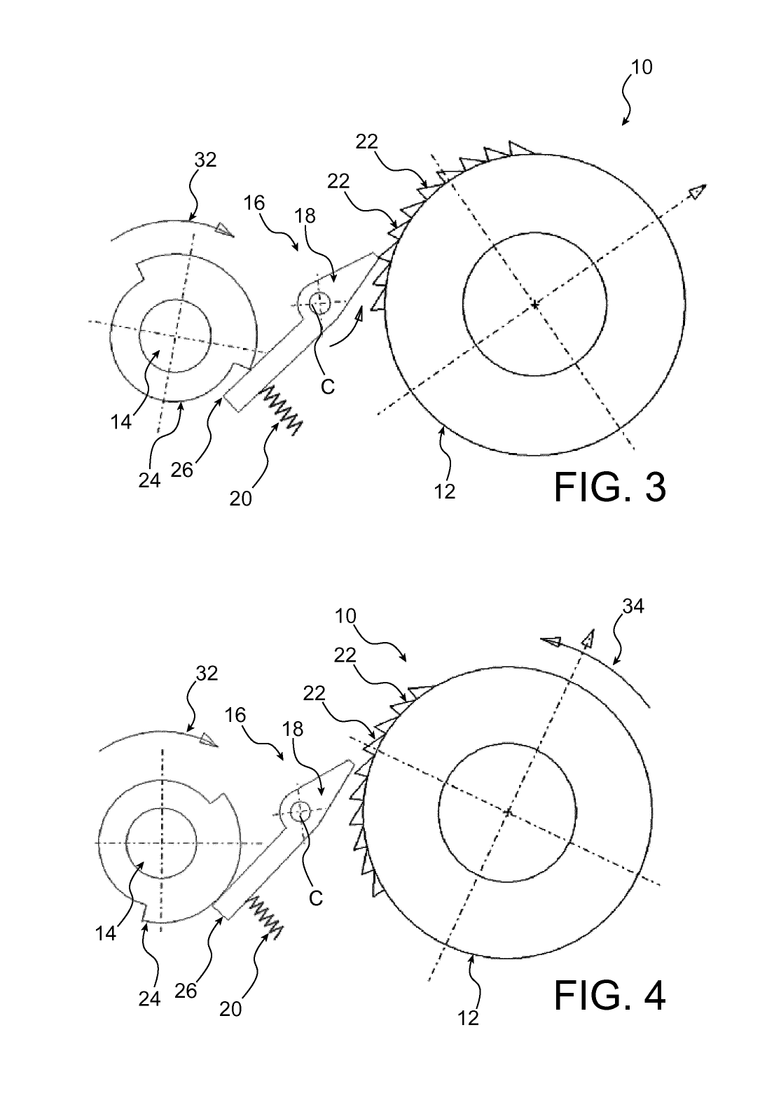

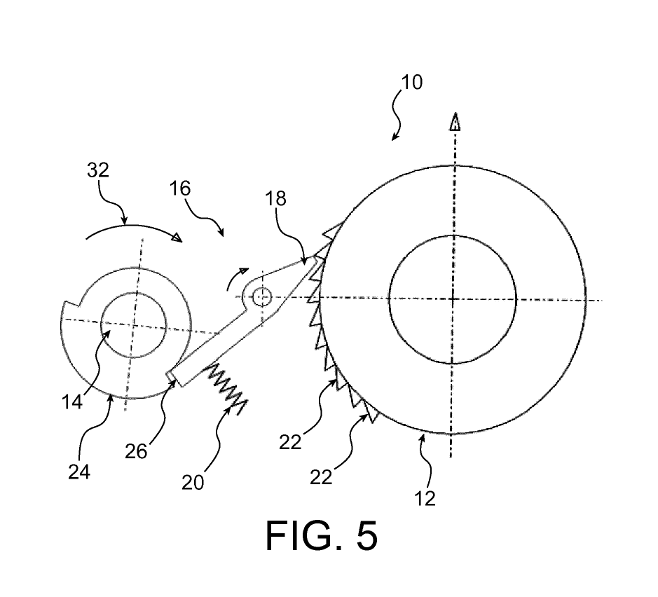

Main shaft 12 is rotatable around its main axis A between a first position, represented in FIG. 1 and FIG. 5, corresponding to the closed state of the circuit breaker, and a second position represented in FIG. 3, corresponding to an opened state of the circuit breaker.

The drive unit 10 comprises means for driving the main shaft 12 from the first position to the second position and means for driving the main shaft 12 from the second position to the first position.

The means for driving the main shaft 12 from the first position to the second position comprise a spring (not shown) which is preloaded and which continuously exerts a force driving the main shaft 12 towards the second position. First latching means maintain the main shaft 12 in its first position and act against the force exerted by the spring on the main shaft 12.

When the first latching means are released, the main shaft 12 rotates towards its second position, under the action exerted by the spring, the rotation of the mains shaft 12 corresponds to the transition between the state represented in FIG. 1 and the state represented in FIG. 2.

The means for driving the main shaft 12 from the second position to the first position comprise a secondary shaft 14 which engages the main shaft 12 by a transmission gear (not shown) and which is driven for example by an electric motor.

The secondary shaft 14 is parallel to the main shaft 12 and its main axis B is offset with respect to main axis A of the main shaft 12.

The drive unit 10 also comprises second latching means 16 to prevent the main shaft 12 from rotating from the second position towards the first position.

These second latching means 16 are safety means, preventing an accidental closure of the circuit breaker.

These second latching means 16 are also releasable, in order to allow the rotation of the main shaft 12 from the second position towards the first position when they are released, at the moment the circuit breaker is intended to close.

The second latching means 16 comprise a retention pawl 18 which removably engages the main shaft 12. The pawl 18 is able to rotate around a third axis C parallel and offset with respect to the two other axis A and B, between an engaged position and a disengaged position.

Here, the main shaft 12 comprises multiple teeth 22 arranged on its periphery, with which teeth 22 the pawl 18 cooperates when he is in its engaged position.

A return spring 20 continuously urges the pawl 18 towards its engaged position.

Then, when the pawl 18 is in its engaged position, and when the main shaft 12 rotates from its first position towards its second position, the slanted edge of the teeth 22 push the pawl up. Then the pawl 18 doesn't block the rotation of the main shaft 12 in this direction.

When the main shaft 12 tends to rotate in the other direction, the pawl 18 presses against the radial edge of one tooth 22, blocking the rotation of the main shaft 12 in this direction.

Accordingly, when the pawl 18 engages with the main shaft 12, it permits the main shaft 12 to rotate towards the second position but it prevents the main shaft 12 to rotate from the second position towards the first position.

When the pawl 18 is not engaged with the main shaft 12, the main shaft 12 is free to rotate in both directions, under the action of the spring or the secondary shaft 14.

The drive unit 10 also comprises means for rotating the pawl 18 around its axis C from the engaged position to a released position shown for example in FIG. 4.

To this end, the drive unit 10 comprises a rotating cam 24 which is able to press against a leg 26 of the pawl 18, and exerts a driving force against the return action exerted by the spring 20.

As a best mode of implementation of the invention, the cam 24 is mounted on the secondary shaft 14 and then rotates simultaneously with it.

This allows disengaging the pawl 18 from the main shaft 12 only when the main shaft 12 is needed to rotate from its second position towards its first position.

The cam profile and the transmission gear between the main shaft and the secondary shaft are designed so that during the rotation of secondary shaft 14, the cam 24 presses against the leg 26 of the pawl 18 while the secondary shaft 14 is coupled with the main shaft 12.

Thus there is no risk of blocking the shafts 12, 14 by the pawl 18 when driving the main shaft 12 towards its first position, and no risk of releasing the main shaft 12 towards its second position when the pawl 18 is disengaged from the main shaft 12.

The operation of the drive unit 10 will be described with reference to the drawings.

In FIG. 1, the main shaft 12 is in its first position corresponding to the closed state of the circuit breaker. The pawl 18 is in its engaged position with the teeth 22 on the main shaft, the secondary shaft 14 and the cam 24 are in an angular position in which they don't cooperate respectively with the main shaft 12 and the leg 26 of pawl 18.

Also, the preloaded spring exerts a force driving the main shaft 12 towards the second position but the main shaft 12 is maintained in its first position by the latching means 16.

The transition from the configuration represented in FIG. 1 to the configuration of FIG. 2, corresponds to the rotation of the main shaft towards the second position, under the action of the preloaded spring, as represented by arrow 30.

This rotation occurs after the first latching means have been released.

As explained before, the pawl 18 doesn't restrict the movement of the main shaft 12 towards its second position but prevents the rotation of the main shaft 12 towards its first position by the cooperation with the teeth 22.

For driving the main shaft 12 towards its first position, secondary shaft 14 rotates around its main axis B, as represented by arrow 32 in FIGS. 3 to 5.

In a first step represented in FIG. 3, the cam 24 comes in contact with the leg 26 of the pawl 18. Simultaneously, the transmission gear connects the main shaft 12 with secondary shaft 14.

In a second step, represented in FIG. 4, the secondary shaft 14 further rotates. This results in the disengagement of the pawl 18 from the teeth 22, to allow rotation of the main shaft 12 towards its first position, as represented by arrow 34.

In a third step represented in FIG. 5, the cam 24 ceases to press against the leg 26 of the pawl 18. Thus, the pawl 18 rotates back to cooperate with the teeth 22 to prevent the rotation of the main shaft 12 and the transmission gear disconnects the main shaft 12 from secondary shaft 14.

If the main shaft 12 is not in its first position, another rotation of secondary shaft 14 is performed, as described above.

1. Drive unit for a high and medium voltage circuit breaker comprising
a main shaft being rotatable around its main axis between a first position corresponding to a closed state of the circuit breaker and a second position corresponding to an opened state of the circuit breaker,
elastic means for driving the main shaft in rotation towards the second position, and
releasable means for preventing the rotation of the main shaft from the second position towards the first position,
wherein the releasable means comprise a retention pawl which removably engages the main shaft and which, when engaged, enables the main shaft to rotate towards the second position but prevents its rotation from the second position towards the first position.

2. Drive unit according to claim 1, further comprising a rotating cam which selectively engages the retention pawl to drive the pawl in a position disengaged from the main shaft.

3. Drive unit according to claim 1 further comprising a secondary shaft engaging with the main shaft, for driving the main shaft in rotation from the second position towards the first position.

4. Drive unit according to claim 2, wherein the secondary shaft engages with the main shaft when the rotating cam engages the retention pawl.

5. Drive unit according to claim 2, wherein the rotating cam is mounted on the secondary shaft.

6. Drive unit according to claim 1, wherein the main shaft comprises multiple teeth for engaging with the retention pawl.

7. Drive unit according to claim 2, wherein the pawl comprises a leg on which the cam presses to rotate the pawl from a position engaged with the main shaft to a position disengaged from the main shaft.

8. Drive unit according to claim 2, further comprising a return spring continuously urging the pawl towards its engaged position.
